(19) United States
(12) Patent Application Publication
(10) Pub. No.: US 2005/0204007 A1
(43) Pub. Date: Sep. 15, 2005

(54) Apparatus method and system for automatically populating an interactive messaging contact list

(75) Inventors: Michael Ian McGregor, Apex, NC (US); William Gabriel Pagan, Durham, NC (US)

Correspondence Address: KUNZLER & ASSOCIATES, 8 EAST BROADWAY, SUITE 600, SALT LAKE CITY, UT, 84111, US

(73) Assignee: INTERNATIONAL BUSINESS MACHINES CORPORATION, Armonk, NY (US)

(21) Appl. No.: 10/800,347

(22) Filed: Mar. 12, 2004

(51) Int. Cl. G06F 15/16

(52) U.S. Cl. 709/206; 709/217

(57) ABSTRACT

Information related to online users associated with a user is retrieved from one or more contact sources and parsed to resolve contact information such as email addresses, first names, and last names. The retrieved contact information is validated on a messaging server, presented to a user for acceptance or rejection, and automatically added to a user's interactive messaging contact list. In certain embodiments, a confirmation request is sent to an inserted contact to further confirm the validity of the contact information and prevent misuse.

### BACKGROUND OF THE INVENTION

1 Field of the Invention

The present invention relates to online communication systems. Specifically, the invention relates to apparatus, methods, and systems for populating an interactive messaging contact list.

2. Description of the Related Art

Online communications have experienced steady advances in functionality and ease of use that parallel the advancements in computer communications and networking. Initially, the advent of the modem and the personal computer facilitated direct modem communications between users over existing telephone lines. Later, the development of local area networks facilitated direct or deferred communications such as email with other users of a local area network. Recently, the advent and growth of the internet has proliferated such communications to any user with an internet connection anywhere in the world.

The ubiquitous availability of online communications infrastructure has spurred the development of real-time interactive messaging in which correspondents can send messages instantaneously and respond while each is still online. Additionally, the development of interactive messaging contact lists enable a user to be alerted to the online status of any listed contacts and initiate communications with a selected contact. Despite widespread availability of interactive messaging and the infrastructure associated therewith, certain hurdles have limited the widespread adoption of interactive messaging. One of these hurdles is compiling a list of contacts and their associated communication handles or login names.

Typically, each user has a wide variety of business, family, community, and personal associates whom they may wish to contact. Although many users have contact lists for sending electronic mail to the aforementioned associates, relatively few have contact lists for sending real-time interactive messages. In order to compile an interactive messaging contact list, users typically manually enter or copy information for each contact into an interactive messaging contact list associated with a specific interactive messaging application. Such a process has proven to be tedious and error prone and may need to be repeated when switching to a different interactive messaging application. Furthermore, a messaging handle or login name for a user may not be known for a contact, particularly since messaging handles and login names are typically not associated with sending electronic mail.

Given the aforementioned issues and challenges related to interactive messaging and the shortcomings of currently available solutions, a need exists for an apparatus, method, and system for automatically populating an interactive messaging contact list. Specifically, what is needed is a method, apparatus and system for automatically compiling an interactive messaging contact by searching contact information sources associated with a user, extracting relevant contact information, validating the contact information with a messaging server, presenting the contact information to the user for approval, and automatically adding approved contact information to the users interactive messaging contact list. Beneficially, such an apparatus, method, and system would increase the utility and use of interactive messaging and the infrastructure associated therewith.

### SUMMARY OF THE INVENTION

The present invention has been developed in response to the present state of the art, and in particular, in response to the problems and needs in the art that have not yet been fully solved by currently available online communication systems. Accordingly, the present invention has been developed to provide an apparatus, method, and system for automatically populating an interactive messaging contact list that overcome many or all of the above-discussed shortcomings in the art.

In one aspect of the present invention an apparatus for automatically populating an interactive messaging contact list includes a retrieval module that retrieves contact information corresponding to online users associated with a user from a plurality of contact sources including at least one electronic address book, a validation module that validates the contact information on a messaging server to provide validated contact information, and an insertion module that adds the validated contact information to an interactive messaging contact list.

In certain embodiments, the validation module prompts a user to resolve conflicts in contact information, verify the contact information including a login name or messaging handle, and enables a user to select or deselect contacts for insertion into the interactive messaging contact list. Enabling a user to select or deselect contacts facilitates compilation of a contact list that is personalized for a particular user.

In another aspect of the invention a method for automatically populating an interactive messaging contact list includes retrieving contact information corresponding to online users associated with a user from a plurality of contact sources including at least one electronic address book, validating the contact information on a messaging server to provide validated contact information, and adding the validated contact information to an interactive messaging contact list.

The method may also include searching for contact sources on storage devices, storage networks, or other data repositories such as email servers. In one embodiment, searching for contact sources include searching for files having a specific format such as a Lotus Notes format, an Eudora Mail format, a Microsoft Outlook format, of the like. Once a source is found, contact information may be extracted by parsing the data for specific information such as an email address, a first name, and last name.

Various elements of the present invention may be combined into a system arranged to carry out the functions or steps presented above. In one embodiment, the system includes a client computer configured to retrieve contact information corresponding to online users associated with a user from a plurality of contact sources including at least one electronic address book, and a messaging server configured to validate the contact information. In certain embodiments, the messaging server is queried for a specific messaging handle or login name associated with a contact.

The present invention facilitates compilation of interactive messaging contact lists in a convenient useful manner. These and other features and advantages of the present invention will become more fully apparent from the following description and appended claims, or may be learned by the practice of the invention as set forth hereinafter.

It should be noted that reference throughout this specification to features, advantages, or similar language does not imply that all of the features and advantages that may be realized with the present invention should be, or are in, any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic diagram illustrating one embodiment of an interactive messaging system of the present invention;

FIG. 2 is a block diagram illustrating one embodiment of a contact collection apparatus of the present invention; and

FIG. 3 is a flow chart diagram depicting one embodiment of a contact list population method of the present invention.

### DETAILED DESCRIPTION OF THE INVENTION

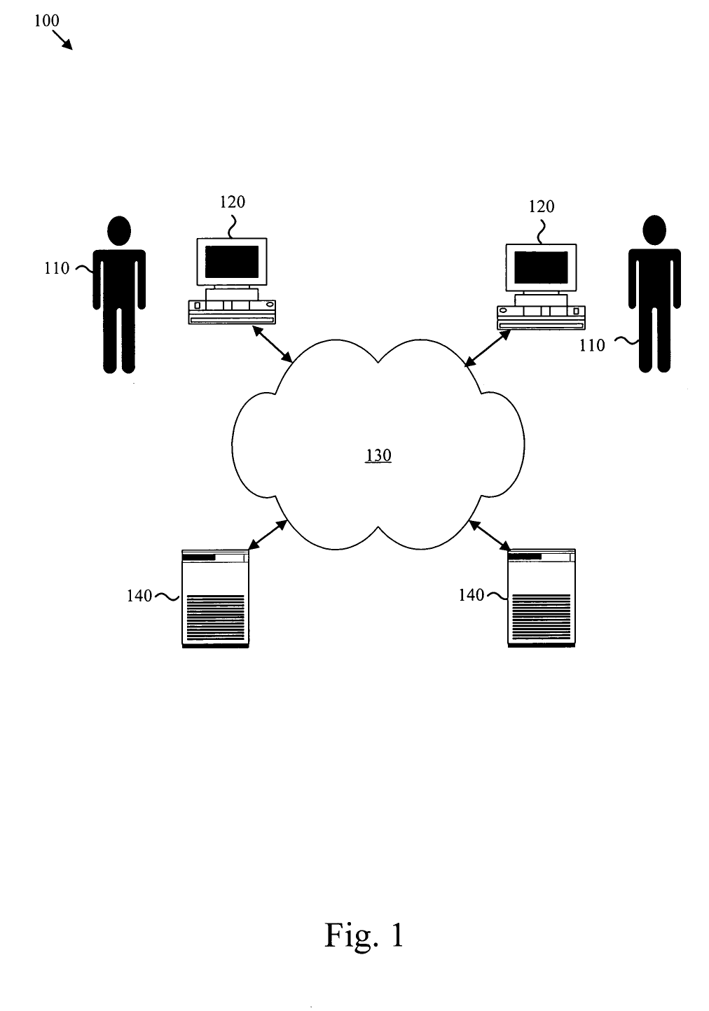

It will be readily understood that the components of the present invention, as generally described and illustrated in the Figures herein, may be arranged and designed in a wide variety of different configurations. Thus, the following more detailed description of the embodiments of the apparatus, method, and system of the present invention, as represented in FIGS. 1 through 3, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The features, structures, or characteristics of the invention described throughout this specification may be combined in any suitable manner in one or more embodiments. For example, reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” or similar language throughout this specification do not necessarily all refer to the same embodiment and the described features, structures, or characteristics may be combined in any suitable manner in one or more embodiments.

The present invention sets forth an apparatus, system and method for automatically populating an interactive messaging contact list. Contact information is extracted from one or more contact sources, validated, resolved, and inserted into an interactive messaging contact list in an automated convenient manner.

FIG. 1 is a schematic diagram illustrating an interactive messaging system 100 of the present invention. As depicted, the interactive messaging system 100 includes one or more users 110 with computer systems enabled with the present invention 120, a network 130, and one or more messaging servers 140. The interactive messaging system 100 automatically populates an interactive messaging contact list (not shown) associated with each user and reduces the complexity of messaging with other users.

The users 110 conduct interactive electronic messaging sessions with specified contacts. The users' computer systems 120 configured according to the present invention discover, retrieve, and parse contact information from sources residing on the users' computer systems, the messaging servers 140, or other servers such as email servers (not shown).

The network 130 transfers contact information to the messaging servers 140 for validation, extends the contact information search to the messaging servers, and returns validated information to the users'computer systems. In one embodiment, the network 130 is an inter-network such as the internet. The messaging servers 140 validate the contact information. The validated contact information is inserted into a users interactive messaging contact list (not shown).

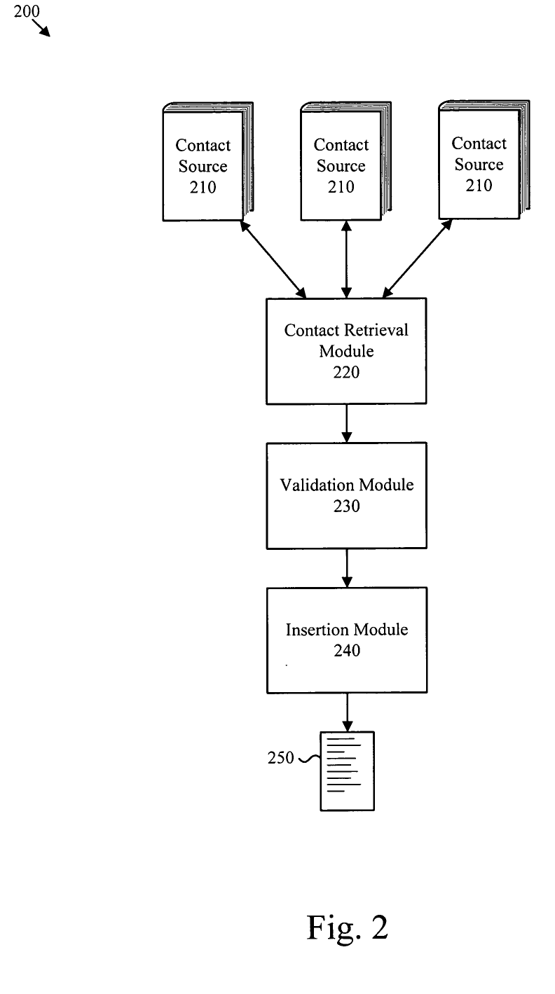

FIG. 2 is a block diagram illustrating one embodiment of a contact collection apparatus 200 of the present invention. As depicted, the contact collection apparatus 200 includes one or more contact information sources 210, a contact retrieval module 220, a validation module 230, an insertion module 240, and an interactive messaging contact list 250. The contact collection apparatus 200 facilitates initializing and updating the interactive messaging contact list 250 in an automatic manner.

The contact information sources 210 provide contact information for users associated with a particular user such as the user of a local computer. In the depicted embodiment, the contact information sources are address books that may have different storage formats. The contact retrieval module 220 searches the contact information sources 210 and extracts contact information for one or more users.

The validation module 230 communicates with the messaging server in order to validate the contact information. In certain embodiments, the validation module may also prompt the user resolve conflicts, verify the identity of a contact, and accept or reject each contact. The insertion module 240 inserts accepted contacts into the interactive messaging list 250. The interactive messaging list 250 may be stored on a data store (not shown) for subsequent use.

The possibility exists that a contact may be erroneously or inadvertently inserted into the interactive messaging list 250 or maliciously inserted by a virus. To address such situations, certain embodiments require approval of the identified contact before a contact may be added to the interactive messaging list 250 or sent an interactive message by the user. In one embodiment, the insertion module 240 assigns a provisional status to the inserted contact and generates a contact confirmation request that must be confirmed by the contact in question before the user is allowed to initiate interactive messages with the contact. The contact confirmation request may comprise an email message. In one embodiment, a positive confirmation changes the provisional status to non-provisional status, and a negative confirmation removes the inserted contact from the messaging contact list.

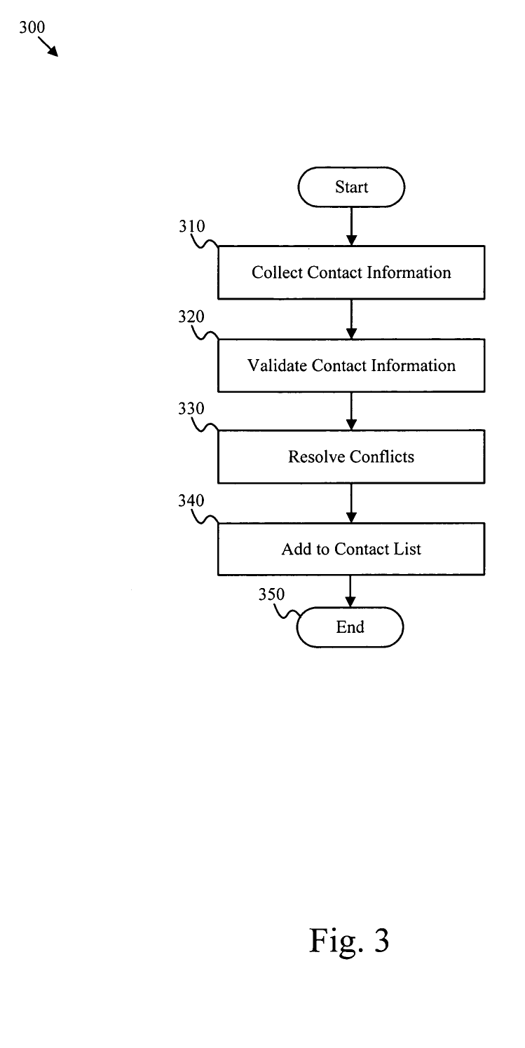

FIG. 3 is a flow chart diagram depicting one embodiment of a contact list population method 300 of the present invention. As depicted, the contact list population method 300 includes a data collection step 310, a validation step 320, a resolution step 330, and an insertion step 340. The contact list population method 300 may be conducted in conjunction with, or independent of, the contact collection apparatus 200 shown in FIG. 2.

The data collection step 310 collects contact information from multiple contact sources such as the contact sources 210 depicted in FIG. 2. The contact sources may be electronic address books stored locally or online. In certain embodiments, the data collection step 310 searches a local computer, messaging servers, and email servers for contacts associated with a particular user. In one embodiment, the data collection step 310 searches for files conforming to a Lotus Notes address format, an Eudora Mail address book format, and a Microsoft Outlook format.

The validation step 320 accesses a messaging server such as the messaging server 140 to validate the contact information. In one embodiment, all messaging handles or user names that match the contact information are retrieved from the messaging server. The resolution step 330 resolves conflicts that may arise such as multiple handles or user names having similar contact information, prompts the user to resolve conflicts, and allows the user to select or deselect specific contacts. The insertion step 340 adds the validated and selected contacts to a user's interactive messaging contact list. In certain embodiments, the contacts are provisionally inserted subject to confirmation by the actual contact.

The present invention facilitates populating an interactive messaging contact list in an automatic manner. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for automatically populating an interactive messaging contact list, the apparatus comprising:
a retrieval module configured to retrieve contact information corresponding to online users from a plurality of contact sources associated with a user including at least one electronic address book;
a validation module configured to validate the contact information on a messaging server to provide validated contact information; and
an insertion module configured to add the validated contact information to an interactive messaging contact list.

2. The apparatus of claim 1, wherein the retrieval module is further configured to search storage devices and other data repositories for a known address book format.

3. The apparatus of claim 2, wherein the known address book format is selected from the group consisting of a Lotus Notes format, an Eudora Mail format, and a Microsoft Outlook format.

4. The apparatus of claim 1, wherein the retrieval module is further configured to extract contact information by parsing an email address retrieved from the data sources.

5. The apparatus of claim 1, wherein the retrieval module is further configured to extract contact information by parsing a first and last name retrieved from the data sources.

6. The apparatus of claim 1, wherein the retrieval module is further configured to prompt a user to resolve conflicts in contact information.

7. The apparatus of claim 1, wherein the insertion module is further configured to enable a user to selectively insert contacts into the interactive messaging contact list.

8. A method for automatically populating an interactive messaging contact list, the method comprising:
retrieving contact information corresponding to online users associated with a user from a plurality of contact sources including at least one electronic address book;
validating the contact information on a messaging server to provide validated contact information; and
adding the validated contact information to an interactive messaging contact list.

9. The method of claim 8, further comprising searching storage devices and other data repositories for a known address book format.

10. The method of claim 9, wherein the known address book format is selected from the group consisting of a Lotus Notes format, an Eudora Mail format, and a Microsoft Outlook format.

11. The method of claim 8, further comprising parsing the contact information.

12. The method of claim 11, wherein parsing the contact information comprises resolving a first and last name.

13. The method of claim 8, further comprising prompting a user to resolve conflicts in the contact information.

14. The method of claim 8, further comprising enabling a user to selectively insert contacts into the interactive messaging contact list.

15. The method of claim 8, further comprising generating a confirmation request for an inserted contact.

16. An apparatus for automatically populating an interactive messaging contact list, the apparatus comprising:
means for retrieving contact information corresponding to online users associated with a user from a plurality of contact sources including at least one electronic address book;
means for validating the contact information on a messaging server to provide validated contact information; and
means for adding the validated contact information to an interactive messaging contact list.

17. A system for automatically populating an interactive messaging contact list, the system comprising:
a client computer configured to retrieve contact information corresponding to online users associated with a user from a plurality of contact sources including at least one electronic address book;
a messaging server configured to validate the contact information; and
the client computer further configured to add the validated contact information to an interactive messaging contact list.

18. The system of claim 17, wherein the client computer is further configured to prompt a user to resolve conflicts in contact information.

19. The system of claim 17, wherein the client computer is further configured to enable a user selectively insert contacts into the interactive messaging contact list.

20. A computer readable storage medium comprising computer readable program code configured to carry out a method for automatically populating an interactive messaging contact list, the method comprising:
retrieving contact information corresponding to online users associated with a user from a plurality of contact sources including at least one electronic address book;
validating the contact information on a messaging server to provide validated contact information; and
adding the validated contact information to an interactive messaging contact list.

21. The computer readable storage medium of claim 20, wherein the method further comprises prompting a user to resolve conflicts in contact information.

22. The computer readable storage medium of claim 20, wherein the method further comprises enabling a user to selectively insert contacts into the interactive messaging contact list.

23. The computer readable storage medium of claim 20, wherein the method further comprises generating a confirmation request for an inserted contact.
